(19) United States
(12) Patent Application Publication
(10) Pub. No.: US 2016/0264051 A1
(43) Pub. Date: Sep. 15, 2016

(54) Night Driving System and Method

(71) Applicant: Visionize Corp., Berkeley, CA (US)

(72) Inventor: Frank Werblin, Berkeley, CA (US)

(73) Assignee: Visionize Corp., Berkeley, CA (US)

(21) Appl. No.: 14/984,218

(22) Filed: Dec. 30, 2015

Related U.S. Application Data
(60) Provisional application No. 62/131,957, filed on Mar. 12, 2015.

(51) Int. Cl. B60R 1/00; H04N 5/33; G06K 9/46; G06K 9/00; H04N 5/247; H04N 5/232

(52) U.S. Cl. CPC B60R 1/00; H04N 5/247; H04N 5/23293; G06K 9/4661; G06K 9/00805; H04N 5/23238; H04N 5/33

(57) ABSTRACT

A system and method is presented for the enhancement of a user's vision using a head-mounted device. The user is presented with an enhanced view of the scene in front of them. One system and method reduces the glare from lights or the sun. Another system and method provides increased contrast for the darkest parts of a scene.

### CROSS-REFERENCE TO RELATED APPLICATIONS

This application claims the benefit of U.S. Provisional Application Ser. No. 62/131,957, filed Mar. 12, 2015, the contents of which are hereby incorporated by reference in their entirety.

### BACKGROUND OF THE INVENTION

1. Field of the Invention

The present invention generally relates to a vision-enhancement system and method and, more particularly, to a head-mounted method and system for vision-enhancement in the presence of glare from lights or the sun.

2. Discussion of the Background

Driving at night can be difficult due to the glare of oncoming headlights and the reduced illumination of other road hazards such as crossing pedestrians and unmarked road obstacles. The difficulty is compounded for older adults due to the development of cataracts. At some point in their lives, a person's vision may deteriorate to the point where they cannot drive at night.

There is thus a need in the art for a method and apparatus that permits people with deteriorating eyesight to drive in the presence of glare. Such a system should be easy to use, provide a wide field of view, and present a scene to a person with deteriorating eyesight that enables them to drive.

### BRIEF SUMMARY OF THE INVENTION

The present invention overcomes the limitations and disadvantages of prior art vision-enhancement systems and methods by providing the user with a head-mounted system that provides a view to the user with improved contrast for those with impaired vision.

Certain embodiments provide a portable vision-enhancement system wearable by a user to view a brightness-modified scene. The system comprises: a right digital camera which, when worn by the user, is operable to obtain right video images the scene in front of the user; a left digital camera which, when worn by the user, is operable to obtain left video images of the scene in front of the user; a left screen portion viewable by the left eye of the user; a right screen portion viewable by the right eye of the user; and a processor. The processor is programmed to: accept the left video images, modify the accepted left video images by limiting the maximum brightness in the images to be less than a predetermined brightness, provide the modified left video images for display on the left screen portion, accept the right video images, modify the accepted right video images by limiting the maximum brightness in the images to be less than a predetermined brightness, and provide the modified right video images for display on the right screen portion.

Certain other embodiments provide a method of enhancing vision for a user using a system with a left digital camera operable to obtain left images of a scene, a right digital camera operable to obtain right images of a scene, a left screen portion to provide a left image to the left eye of a user, a right screen portion to provide a right image to the right eye of the user, and a processor to accept images from the cameras and provide processed images to the screens. The method includes: accepting the left video images; modifying the accepted left video images by limiting the maximum brightness in the images to be less than a predetermined brightness; displaying the modified left video images on the left screen portion; accepting the right video images; modifying the accepted right video images by limiting the maximum brightness in the images to be less than a predetermined brightness; and displaying the modified right video images on the right screen portion.

These features together with the various ancillary provisions and features which will become apparent to those skilled in the art from the following detailed description, are attained by the vision-enhancement system and method of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a schematic of a vision-enhancement system;

FIG. 2A is a perspective view of a first embodiment vision-enhancement system;

FIG. 2B is a sectional view 2B-2B of FIG. 2A;

FIG. 2C is a sectional view 2C-2C of FIG. 2A;

FIG. 3A is an image which is a representation of an image from a sensor as obtained by the processor;

FIG. 3B is an image that illustrates the processing of image by the brightness limiting algorithm;

FIG. 3C is an image that illustrates a displayed image after passing through the brightness limiting algorithm; and

FIG. 3D is an image that illustrates an image after passing through a contrast-enhancing algorithm.

Reference symbols are used in the Figures to indicate certain components, aspects or features shown therein, with reference symbols common to more than one Figure indicating like components, aspects or features shown therein.

### DETAILED DESCRIPTION OF THE INVENTION

Certain embodiments of the inventive vision-enhancement system described herein include: 1) a pair of video cameras positioned to capture a pair of video images of the scene that would be in the user's field of view if they were not wearing the system; 2) a processor to modify the captured videos; and 3) screens positioned to present the processed stereo video images to the user's eyes. The system thus preserves depth perception afforded by binocular vision while enhancing images of the scene to compensate for vision problems of the user.

Certain embodiments of the inventive vision-enhancement system are contained in a head-mounted apparatus. The head-mounted apparatus generally includes a pair of digital video cameras, each with a wide field of view, and displays which present the pair of videos to the wearer. The system also includes a digital processor and memory, which may or may not be part of the head-mounted apparatus, which modifies the images from the cameras before being provided to the displays. The wearer thus sees a stereoscopic view of what is presented on the display, which is an enhancement of the scene. The system is preferably fast enough to provide real-time modified images to the user and has a high enough spatial resolution and field of view to be usable while driving an automobile.

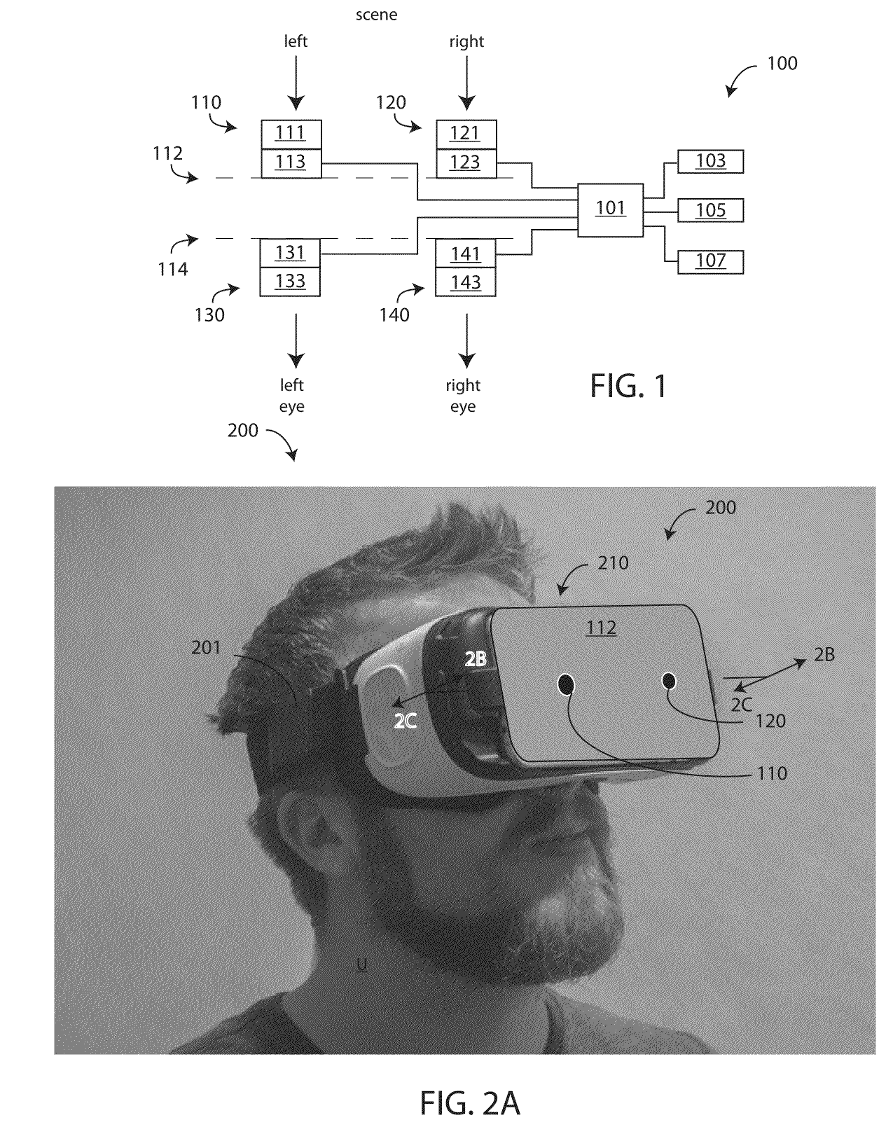

FIG. 1 is a schematic of one embodiment of a vision-enhancement system 100. System 100 includes a pair of digital cameras, shown as a left camera 110 and a right camera 120, a pair of displays, shown as a left display 130 and a right display 140, a digital processor 101, a memory 103, a power supply 105, and optional communications electronics 107. Camera 110 includes a lens 111 and a digital imaging sensor 113, and camera 120 includes a lens 121 and a digital imaging sensor 123. Display 130 includes a screen or screen portion 131 and a lens 133, and display 140 includes a screen or screen portion 141 and a lens 143. Digital processor 101 is in wired or wireless communication with sensors 113 and 123, screens 131 and 141, memory 103, power supply 105, and optional communications electronics 107. Screens 131 and 141 may be separate screens or may be portions of the same screen.

In certain embodiments, cameras 110 and 120 are generally the same—that is, lens 111 is similar to lens 121 and sensor 113 is the same or similar to sensor 123. Cameras 110 and 120 collect a pair of stereo images of a scene, through lenses 111 and 121 and onto sensors 113 and 123, respectively, by virtue of being spaced apart from each other and directed in a direction generally perpendicular to a plane 112.

In one embodiment, which is not meant to limit the scope of the present invention, sensors 113 and 123 are low-light sensors each capable of capturing video images with a 120 degree field-of-view and are laterally spaced by a distance that is approximately the distance between the eyes. Alternatively, the spacing between the cameras may be larger than the eye spacing, thus accentuating stereoscopic distance judgment.

In one embodiment, each sensor 113 and 123 are both imaging sensors having a High Definition sensor, which may be, for example and without limitation, a Fairchild Imaging HWK1910A SCMOS Sensor (Fairchild Imaging, San Jose, Calif.). Lenses 111 and 121 are adjustable to allow a wearer to focus on screens 131 and 141. In another embodiment, sensors 113 and 123 and lenses 111 and 121 are sensitive to light in the near infrared, thus providing enhanced light viewing.

In certain other embodiments, displays 130 and 140 project images from their respective screens 131 and 141, and through their respective lenses 133 and 143 in a direction perpendicular to a plane 114 and spaced apart by the distance between a wearer's eyes. Thus, for example, display 130 presents a processed image viewed by camera 110, and display 140 presents a processed image viewed by camera 120. The wearer is thus presented with a pair of stereo images as captured by cameras 110 and 120.

Displays 130 and 140 are configured to present images with a field-of-view of least 120 degrees to the eyes of the wearer. In one embodiment, the pixel density of each screens 131 and 141 (which may be two separate screens or portions of the same screen) correspond to 1 pixel per minute of arc, which is the resolution for 20/20 vision.

In certain embodiments, memory 103 includes programming for processor 101 for the capture of images from sensors 113 and 123, the modification of video images from the sensors, and for the presenting of processed images to screens 131 and 141. More specifically, digital images from sensors 113 and 123 are modified within processor 101, such that the user is presented with a pair of modified scene images, providing a modified binocular view of the scene.

Processor 101 is a processor such as Adreno 420 GPU, quad-core Snapdragon 805 processor (Qualcomm Technologies, Inc, San Diego, Calif.) and memory 103 has sufficient memory for storing programming accessible by the processor, including memory for temporarily storing frames of video from sensors 113 and 123. Memory 103 includes programming to execute a luminance algorithm executed by processor 101 on images from sensors 113 and 123. In one embodiment, the algorithm limits the maximum brightness of objects in the imaged scene. In another embodiment, the algorithm increases and adjusts the representation of the brightness of poorly illuminated objects in the scene. In various embodiments, as discussed subsequently in greater detail, the modification of the camera images can modify the representation of the brightest parts of the image, thus presenting images that are easier for certain users with impaired vision to see objects at night.

It is preferred that the system 100 has sufficient spatial and temporal resolution to allow for specific tasks, such as driving, and that processor 101 and memory 103 have sufficient computing power and speed to permit real-time processing of images from sensors 113 and 123. In certain embodiments, the video images are acquired and presented at framing rates of 60 frames per second or greater. Such a system can permit a user to see an enhanced or modified version of the scene through system 100 and to respond and interact with the user's environment in real time. In one embodiment, the programming of processor 101 allows system 100, for example, to suppress bright headlights while maintaining headlight visibility.

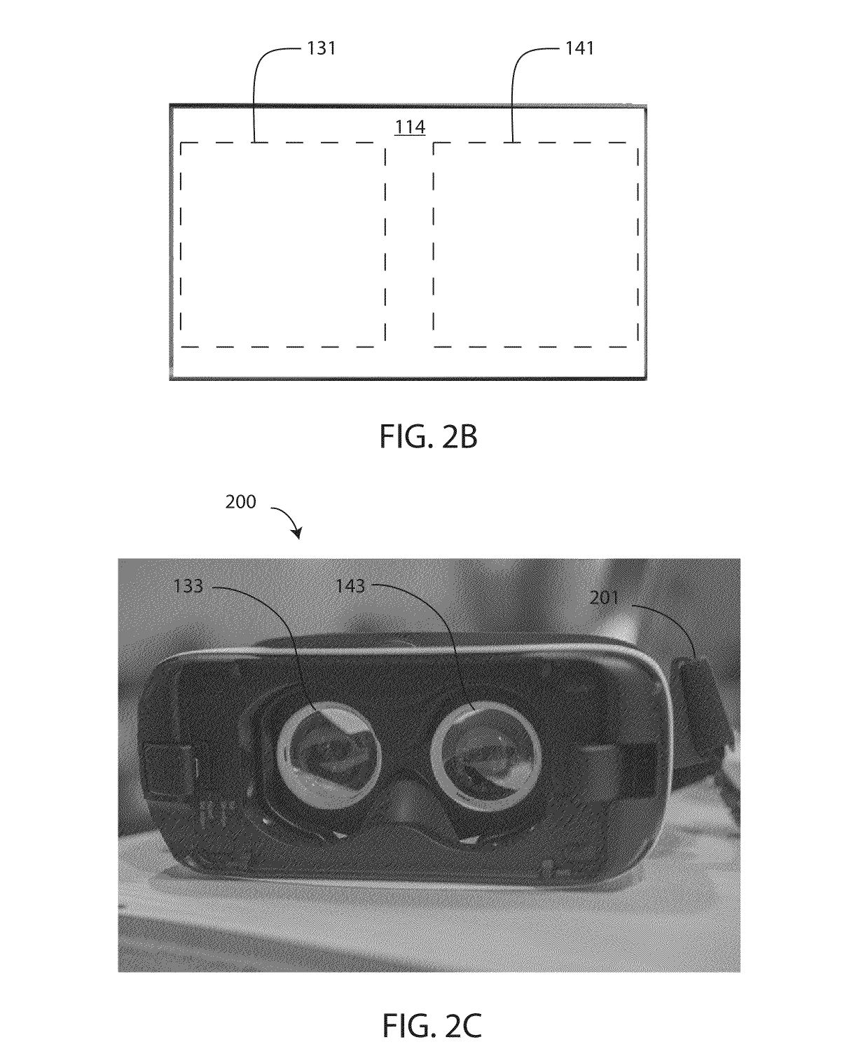

FIG. 2A is a perspective view of a first embodiment vision-enhancement system 200; FIG. 2B is a sectional view 2B-2B of FIG. 2A; and FIG. 2C is a sectional view 2C-2C of FIG. 2A. System 200 is generally similar to system 100, except where explicitly stated.

FIG. 2A shows system 200 as including a housing 210 and a strap 201 for attaching the housing to the head of a wearer U. Housing 210 includes the electrical and optical components described with reference to system 100. Thus, for example, FIG. 2A shows the pair of forward-facing cameras 110 and 120 spaced by a distance on a plane 112.

FIG. 2B is a forward-looking sectional view 2B-2B of housing 210 showing a plane 114 containing screens 131 and 141.

FIG. 2C is a backward-looking sectional view 2C-2C showing adjustable lenses 133 and 143 which may be used by wearer U to focus image screens 131 and 141 onto the eyes of the wearer.

In certain embodiments, memory 103 of system 100 or 200 is provided with programming instructions which, when executed by processor 101, operates sensors 113 and 123 to obtain images, performs image processing operations on the obtained images, and provides the processed images to displays 131 and 141, respectively.

In certain embodiments, the programming stored in memory 103 image processes the images from sensors 113 and 123 to suppress the brightest parts of the image by limiting the representation of the maximum brightness of the images. Thus, for example, the programming may scan each pixel of an image to determine its brightness B(i,j). If the brightness B(i,j) is less than or equal to a preset threshold value B0, then the actual pixel brightness B(i,j) is provided to the screen. If the brightness B(i,j) is greater than the value B0, then the value B(i,j)=B0 is provided to the screen.

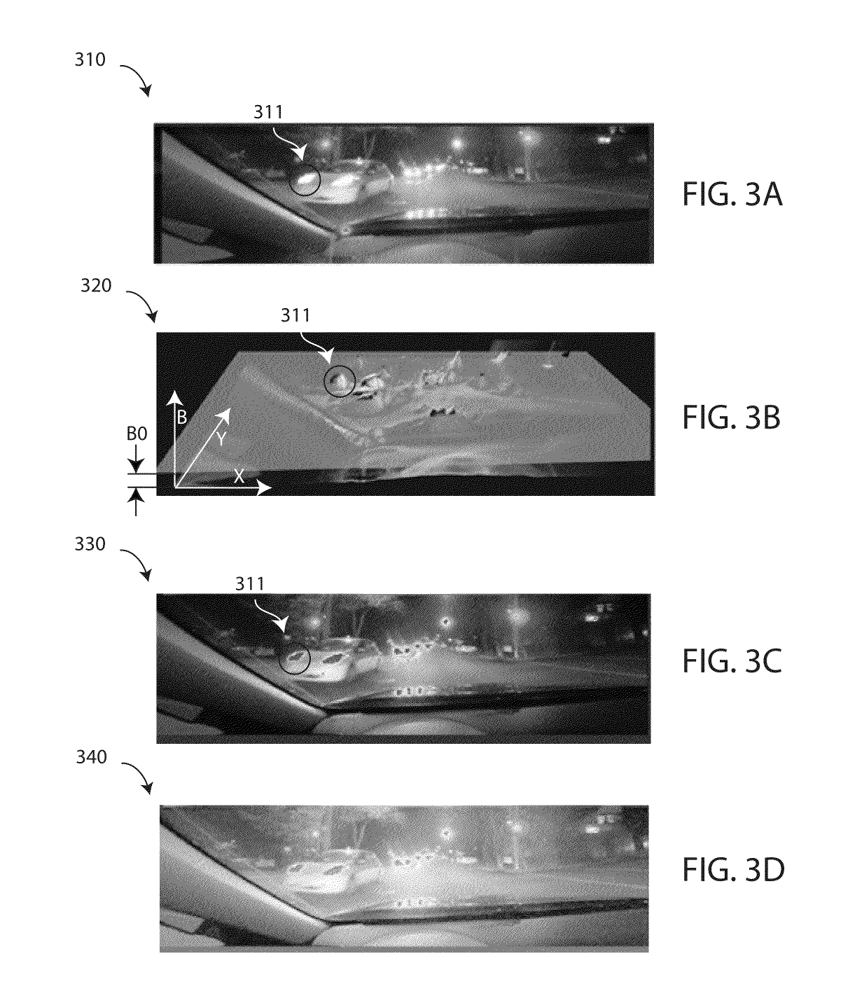

As one example, which is not meant to limit the scope of the invention, brightness-limiting algorithm executed by processor 101 is illustrated in FIGS. 3A, 3B, 3C, and 3D.

FIG. 3A shows an image 310, which is a representation of an image from of a night driving scene from sensor 113 or 123 as obtained by processor 101.

FIG. 3B is an image 320 that illustrates the processing of image 310 by the brightness limiting algorithm. Specifically, image 320 is a perspective view of the image of 310, showing the brightness B of each pixel along the Z axis. Image 320 also shows the threshold brightness B0.

FIG. 3C is an image 330 as the processed image is presented on screen 131 or 141.

FIGS. 3A, 3B, and 3C each indicate, as an example, the headlight 311 of an oncoming automobile. The headlight in image 310 is the brightest part of the image. As shown in image 320, the intensity of the headlight is greater than the threshold value B0. As shown in image 330, the representation of the headlight intensity is limited by the algorithm to B0, as are other bright parts of image 310, while for the less bright parts of the image, the representation of the brightness is the same as in the original image 310.

In place of, or in addition to, the brightness-limiting algorithm, the images may be subjected to a contrast-enhancing algorithm. Contrast-enhancing algorithms may, for example, selectively brighten low intensity pixel values to bring out detail in the darker portions of an image. One example of a contrast-enhancing algorithm is illustrated in FIG. 3D in which image 330 is further processed by a contrast-enhancing algorithm.

In addition to modifying the intensity of images, as described above, system 100 or 200 may include additional features useful for driving. Thus, for example, images obtained by one or more of sensors 131 or 141 may be processed by processor 101 to identify features in the scene and to provide an enhanced indication of these features on display 131 and/or 141. Thus, for example, processor 101 may be programmed to recognize potential driving hazards, including but not limited to stop signs, pedestrian crossings, pedestrians actually crossing, potholes or barriers, or the edge of the road. Processor 101 may then provide highlighting or annotation on display 131 and/or 141, such as further increasing the contrast, brightness or color of recognized elements, or, for example, provide visual or auditory alarms if, for example, the driver is heading toward the edge of the road or not slowing down sufficiently to avoid a hazard.

System 100 or 200 may also generate driving directions, traffic alerts, and other textual information that may be provided on screens 131 and 141. System 100 or 200 may utilize communications electronics 107 to obtain software upgrades for storage in memory 103, driving directions, or other information useful for the operation of the system.

While systems 100 and 200 have been described as providing improved night vision, the invention is not limited to these applications. Thus, for example, system 100 or 200 could also limit the representation of the brightness of the sun or of glare from the sun, and could thus also be used during daylight hours.

One embodiment of each of the devices and methods described herein is in the form of a computer program that executes on a digital processor. It will be appreciated by those skilled in the art embodiments of the present invention may be embodied in a special purpose apparatus, such as a pair of goggles which contain the camera, processor and screen, or some combination of elements that are in communication and which, together, operate as the embodiments described.

It will be understood that the steps of methods discussed are performed in one embodiment by an appropriate processor (or processors) of a processing (i.e., computer) system, electronic device, executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily referring to the same embodiment. Furthermore, the particular features, structures or characteristics may be combined in any suitable manner, as would be apparent to one of ordinary skill in the art from this disclosure in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

What is claimed is:

1. A portable vision-enhancement system wearable by a user to view a brightness-modified scene, said system comprising:
a right digital camera which, when worn by the user, is operable to obtain right video images the scene in front of the user;
a left digital camera which, when worn by the user, is operable to obtain left video images of the scene in front of the user;
a left screen portion viewable by the left eye of the user;
a right screen portion viewable by the right eye of the user; and
a processor programmed to:
accept the left video images,
modify the accepted left video images by limiting the maximum brightness in the images to be less than a predetermined brightness,
provide the modified left video images for display on the left screen portion, accept the right video images,
modify the accepted right video images by limiting the maximum brightness in the images to be less than a predetermined brightness, and
provide the modified right video images for display on the right screen portion.

2. The portable vision-enhancement system of claim 1, where said processor is further programmed to:
modify the accepted left video images by increasing the contrast of the darkest portions of the images; and
modify the accepted right video images by increasing the contrast of the darkest portions of the images.

3. The portable vision-enhancement system of claim 1, where said portable vision-enhancement system is wearable by the driver of an automobile, and where said processor is further programmed to:
identify a potential driving hazard in the scene from an analysis of at least one of said left video images or said right video images; and
provide an indication of the potential driving hazard.

4. The portable vision-enhancement system of claim 3, where said processor is programmed to:
provide an indication of the potential driving hazard on at least one of said left screen portions or said right screen portions.

5. The portable vision-enhancement system of claim 3, where said processor is programmed to:
provide an audible indication of the potential driving hazard.

6. The portable vision-enhancement system of claim 1, where said processor is further programmed to provide driving directions on at least one of said left screen portions or said right screen portions.

7. The portable vision-enhancement system of claim 1, where each of said pair of digital camera has a field of view of at least 120 degrees.

8. The portable vision-enhancement system of claim 1, where said processor accepts and provides images at least 60 frames per second.

9. The portable vision-enhancement system of claim 1, where said right digital camera and said left digital camera obtain images in the near infrared.

10. A method of enhancing vision for a user using a system with a left digital camera operable to obtain left images of a scene, a right digital camera operable to obtain right images of a scene, a left screen portion to provide a left image to the left eye of a user, a right screen portion to provide a right image to the right eye of the user, and a processor to accept images from the cameras and provide processed images to the screens, said method comprising:
accepting the left video images;
modifying the accepted left video images by limiting the maximum brightness in the images to be less than a predetermined brightness;
displaying the modified left video images on the left screen portion;
accepting the right video images;
modifying the accepted right video images by limiting the maximum brightness in the images to be less than a predetermined brightness; and
displaying the modified right video images on the right screen portion.

11. The method of claim 10, further comprising:
modifying the accepted left video images by increasing the contrast of the darkest portions of the images; and
modifying the accepted right video images by increasing the contrast of the darkest portions of the images.

12. The method of claim 10, where the system is wearable by the driver of an automobile, said method further comprising:
identifying a potential driving hazard in the scene from an analysis of at least one of said left video images or said right video images; and
providing an indication of the potential driving hazard.

13. The method of claim 12, further comprising:
providing an indication of the potential driving hazard on at least one of said left screen portions or said right screen portions.

14. The method of claim 12, further comprising:
providing an audible indication of the potential driving hazard.

15. The method of claim 12, further comprising:
providing driving directions on at least one of said left screen portions or said right screen portions.

16. The method of claim 10, where said left digital camera has a field of view of at least 120 degrees, and where said right digital camera has a field of view of at least 120 degrees.

17. The method of claim 10, where said steps are executed at least 60 frames per second.
